(19) United States
(12) Patent Application Publication
(10) Pub. No.: US 2005/0016378 A1
(43) Pub. Date: Jan. 27, 2005

(54) Electro-optical air sterilizer with ionizer & lights

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 10/889,949

(22) Filed: Jul. 12, 2004

(30) Foreign Application Priority Data
Jul. 22, 2003 (CN) 03146093.3
Jul. 22, 2003 (CN) 03277176.2

(51) Int. Cl. B03C 3/38

(52) U.S. Cl. 96/16; 96/224

(57) ABSTRACT

This invention relates to an air purifier that uses both transportation vehicles battery and conventional indoor power supply, employs ultraviolet radioactive rays to kill bacteria, viruses and molds in the air and to increase amount of anions. This air purifier has an infrared remove controller and a ability of providing illuminations. This air purifier draws indoor air in and out of the air purifier through spiral air pipe, which contains many rifle spiral shape air collectors, kills bacteria, viruses and moulds in the air and discharges electricity by means of negative high voltage output through carbon fibers to produce anions, so as to improve quality of the air.

### BACKGROUND OF THE PRESENT INVENTION

1. Field of the Present Invention

The present invention is related to an air purifier and more particularly it relates to a three-in-one electro-optical air purifier with ionizer and lights which employs infrared and enable a ability to turn on and off remotely.

2. Description of Related Arts

In this modern society, illuminating apparatus is a must for families, hospitals, senior citizen centers, shopping malls, theaters, restaurants, office buildings, automobile manufacturers, elevators, various cars, ships, airplanes and trains. Meanwhile, air purifies are commonly used in nowadays. Especially problems of air pollution are getting worst as our society has become more industrialize, more depending on transportation vehicles, and more diseases are transmitted by air.

Most conventional air purifiers require normal indoor power supply such as 220V or 120 volt depending on geographical limitation, while few of those are designed mainly for transportation vehicles, which allow air purifier to function under a power supply generated by automobile, i.e. 12 volt, as transportation vehicles are operating. Almost no conventional air purifier has an ability providing capacity for both indoor power supply and automobile power supply.

Moreover, most conventional air purifiers are designed to function as an independent unit without any ability of illumination. A consumer must purchase an additional illuminating equipment and install it next to an air purifier should he/she wants to have lighting available while enjoying a purified air. In additions, most conventional air purifiers are designed without any infrared ability which limit consumer an ability to turn on and off freely or from a distance while operating such units.

Worsen still; most conventional air purifiers can only separate unwanted airborne particles from air to achieve so-called purification for air. However, this is a well known fact that anions in the air are good for health. It would be beneficial should air purifiers can produce anions while separating unwanted airborne particles from air allows.

### SUMMARY OF THE PRESENT INVENTION

A main object of the present invention is to provide an air purifier has an ability providing capacity for both indoor power supply and automobile power supply.

Another object of the present invention is to provide an air purifier has ability of illumination while purifying the air simultaneously or respectively.

Another object of the present invention is to provide an air purifier has infrared capacity which allow user to control a air purifier within a distance without physically touching it.

Another object of the present invention is to provide an air purifier can produce anions while separating unwanted airborne particles from air flows.

Accordingly, in order to accomplish above objects, the present invention provides an air purifier, which comprises:
a three-dimensional rectangular housing
a spiral air pipe,
an ultraviolet emission tube with pre-determined size is placed inside of said spiral air pipe, and
a ventilator, ultraviolet emission tube, negative high voltage electrical carbonization fiber, remote controller and fluorescent lamp tube.

Said three-dimensional rectangular housing further comprises of:
incoming and outgoing air vents, said negative high voltage carbonization fiber is fixed inside of said outgoing air vent, ultraviolet tube is located at a front portion of said air incoming vent, and said ventilator is placed in a center portion of said three-dimensional rectangular housing.

Said air purifier intakes air that contains viruses, bacteria, and mildews into said air purifier through said incoming air vent. There is a rifle 1 like spiral strip inside of said air purifier to direct moving air passing through Photoelectric air sterilization lattice into said outgoing air lattice. Forcing viruses, bacteria and mildews in the air to contact ultraviolet emission tube, so as said ultraviolet could perish viruses, bacteria and mildews contained in the air effectively. Sanitized air then go through said ionizer, which generates negative ions to increase its ratio in the air thus released fresh air through said air purifier's air outlet will be able to improve indoor air quality.

Other than on and off switch that connects with a power source, the present invention also provide with a remote controller. It allows user to remotely control all of functions and features such as turning on, turning off, to increase or decrease power or level of air out and/or input, to increase and/or decrease level of ions, and/or turning on and off illumination.

### BRIEF DESCRIPTION OF THE DRAWINGS

FIG. 1 is a front view of the present invention.

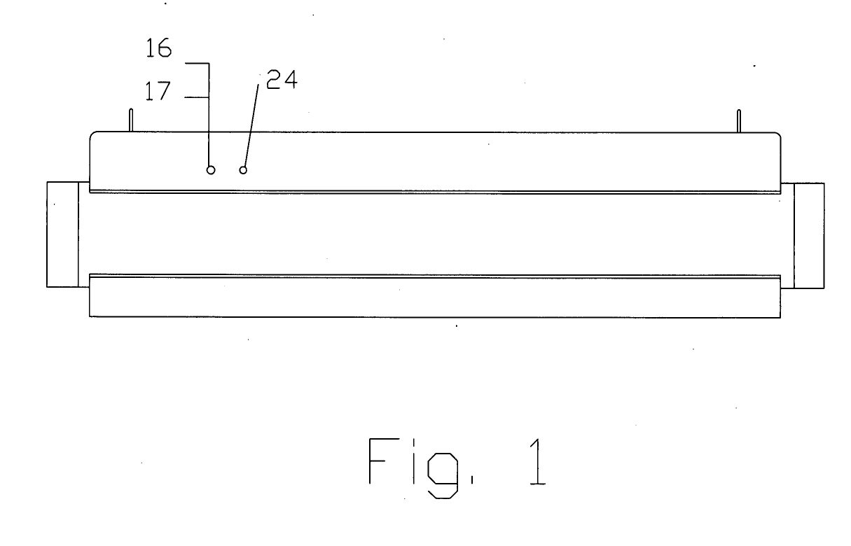

FIG. 2 is a lengthwise section thereof.

FIG. 3 is a side view thereof.

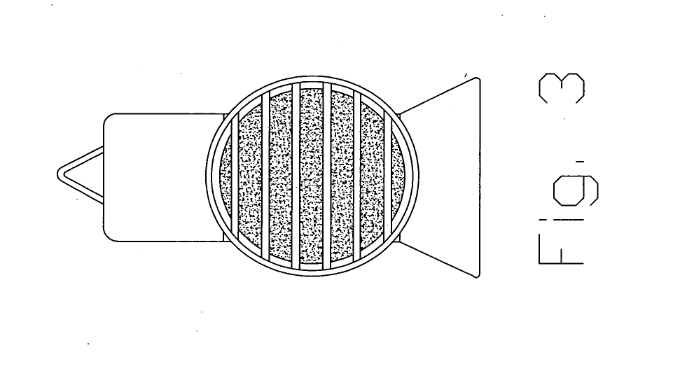

FIG. 4 is a rear view of thereof.

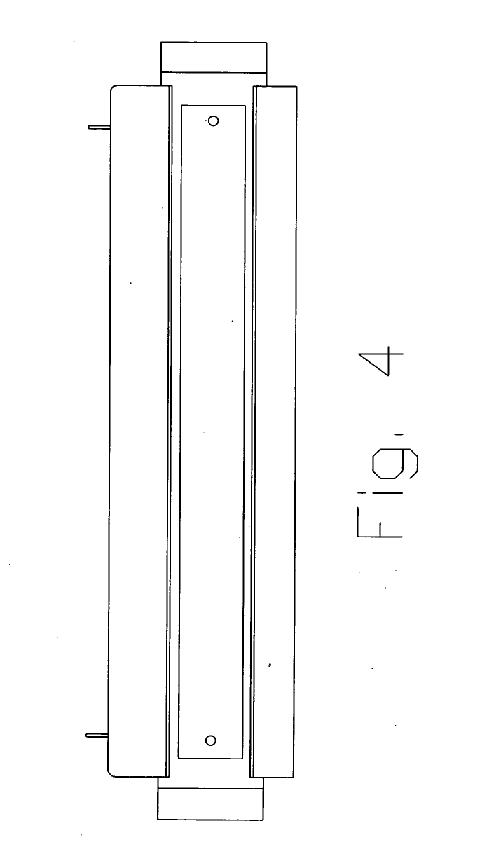

FIG. 5 is another side view thereof.

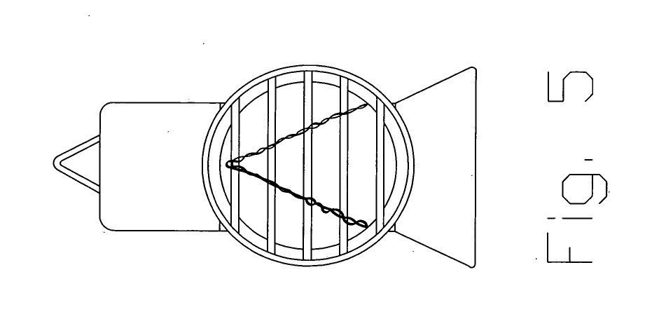

FIG. 6 is a supine view of thereof.

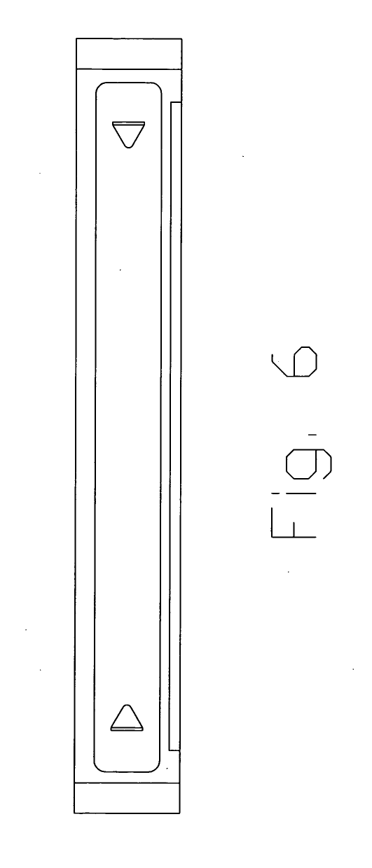

FIG. 7 is a base view thereof.

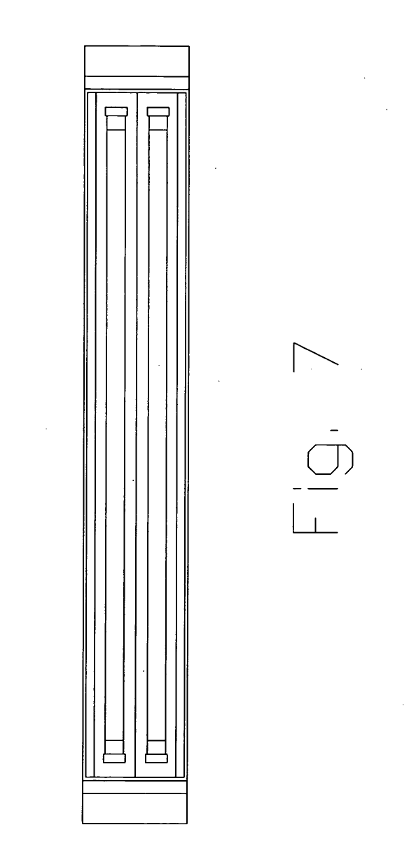

FIG. 8 is a cross profile thereof.

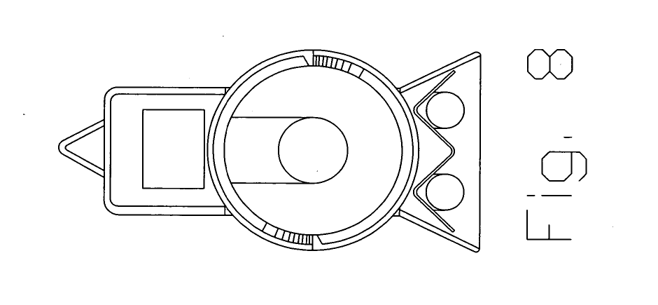

### DETAILED DESCRIPTION OF THE PREFERRED EMBODIMENT

The present invention has a cylinder shaped body (1). An outgoing air lattice (2) is located at a rear portion of said body (1). Said body (1) has an air incoming lattice (3) at front portion of said body (1). Ionized air is released via said outgoing air lattice (2).

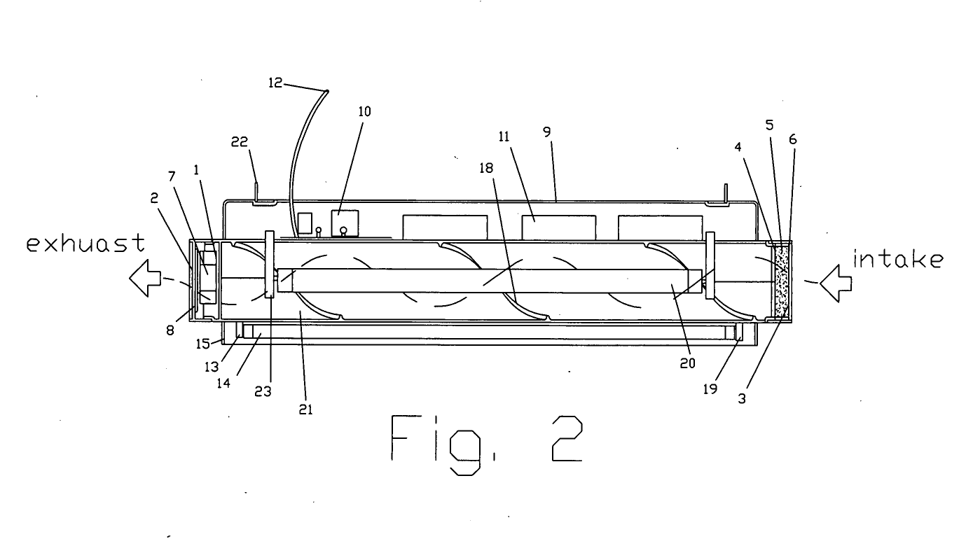

As shown in FIG. 2, there is an incoming air lattice (3) located at front portion of said body (1). Incoming air lattice (3) provides incoming air vent fixed dust filtration shelf (4), dust filtration screen (5), and dust filtration cover (6). A ventilator (7) is located at next to said outgoing air lattice (2). Carbonized fiber (8) is fixed at a front center portion of said outgoing air lattice (2). Under a high negative voltage pressure, ion generator discharges electricity into the air to create negative ions. There is a cover door (23) located at back portion of said body (1). It is fixed with two screws on surface of said body (1). User only needs to turn said two screws to open said cover door (23) to replace ultraviolet emission tube (20).

On top portion of said body (1) is fixed with a power box (9) a power electron generator (10), an electricity rectifier (11), and a power cord (12). There are two metal hooks (22) located on top of said power box (9). Said metal hooks (22) allow said body (1) to be mounted on a ceiling or walls conveniently. At lower part of said body (1), there are two light tube bases (13). Said light tube bases (13) are to fix both ends of fluorescent lamp tube (14). There is a transparent material made protection cover (15) surrounded said fluorescent lamp lube (14).

There are two holes (16) on a side surface of said body (1). One of said holes (16) is to fix different color emission bipolar tube (17) for function indications.

Another hole (16) is fixed as an infrared receiver (24) to interact with remote controller.

In practice, when activating, said ventilator (7) absorbs air with viruses, bacteria and mildews through said dust filtration screen (5), move air into an air collection wall (18) of said body (1) where having a plurality of spiral air collectors (19). Said spiral air collectors are structured based on rifle's spiral shape. It allows moving air easily but slowly gets into said air collection wall (18), then to said outgoing air lattice. Ultraviolet emission tube (20) is located at a center portion of said air collection wall (18). When viruses, bacteria and mildews contaminated air gets into air incoming vent (21), which is between said spiral air collectors (19) and said ultraviolet emission tube (20), ultraviolet emission tube releases ultraviolet to kill said viruses, bacteria, and mildews in the air. Sanitized air is then going through said ventilator (7) to said negative high voltage carbonization fiber (8) which is next to said air outgoing lattice (2), then, sanitized air which is fill of ionizes are and eventually is passing through said outgoing air lattice.

There are different circuits allows power supplies to go through said air purifier.

One circuit goes to said negative high voltage generator circuitry to provide an output of negative high voltage. Another going through rectifier which, provides power via speed controlling circuitry, supplies electricity to said air ventilator (7), and through DC (direct current) to AC (alternate current) converting circuitry to said rectification circuitry that activates said ultraviolet emission tube (20). It operates intermittently every 8 hours. It ignites ultraviolet to perish bacteria, viruses and mildews in the air, while discharging negative high voltage via carbonization fiber to the air to generate negative ions, which is later released by ventilator.

Another path of input power goes through direct current (DC) toward the circuitry of negative ion generator, provides electricity to auto circulating controlling circuitry that activates ultraviolet tube (20), controls operations of negative ion generator and ultraviolet emission tube. It operates intermittently every 4 hours. It stops operations of ultraviolet emission and discharges negative high voltage through carbonization fiber. Said florescent light tube is operated continuously without interruption.

Said air purifier is equipped with an electrical circuitry system and a negative ion generator to increase negative ions and purify air in an indoor environment. Said negative ion generation circuitry, and activate circuitry for ultraviolet emission tube that produces ultraviolet wavelength of 253.7 nanometers and said output value of negative high voltage should be between 4,500 to 8,500 voltages. Said function of activation circuitry's changeable impedance on ultraviolet tube, which generates ultraviolet at 253.7 nm, is to adjust current's output value.

In an indoor environment, when increased negative ions are being inhaled, biochemistry process will be accelerated in human body, lower our hormonal secretion on depression and fatigue. Ultraviolet is able to perish bacteria, viruses and mildews effectively, while illuminator is a must for modern society.

The present invention utilizes ultraviolet emission tube to generate ultraviolet with wavelength of 253.7 nanometers. It effectively kills bacteria, viruses and mildews in the air while ionizer generates negative ions to freshen the air.

1. an air purifier, which comprises:
a three-dimensional rectangular housing
a spiral air pipe,
an ultraviolet emission tube with pre-determined size is placed inside of said spiral air pipe, and
a ventilator,
an ultraviolet emission tube,
an negative high voltage electrical carbonization fiber,
a remote controller and
a fluorescent lamp tube.
Said three-dimensional rectangular housing further comprises of:
incoming and outgoing air vents, said negative high voltage carbonization fiber is fixed inside of said outgoing air vent, ultraviolet tube is located at a front portion of said air incoming vent, and said ventilator is placed in a center portion of said three-dimensional rectangular housing.
There is a rifle like spiral strip inside of said spiral air pipe inside said three-dimensional rectangular housing to direct moving air passing through said air sterilization lattice into said outgoing air lattice.

2. As recited in claim 1, said three-dimensional rectangular housing is having a spiral air pipe;
said spiral air pipe further comprises of:
a rifle like spiral strip, which allows direct more air passing through said air sterilization lattice into said outgoing air lattice located at both ends of said body.

3. An air purifier comprises:
a three dimensional housing, and
at least one set of circuit board, and
at least one anion-generating circuit,
at least one switch,
at least one ultraviolet radioactive ray chamber, and
one air filter frame grid made of rubber or metal material and shaped in rectangular structure,
at least on infrared remote controller and
at least one power input line.
Said three-dimensional rectangular housing further comprises of:
incoming and outgoing air vents, said negative high voltage carbonization fiber is fixed inside of said outgoing air vent, ultraviolet tube is located at a front portion of said air incoming vent, and said ventilator is placed in a center portion of said three-dimensional rectangular housing.
There is a rifle like spiral strip inside of said spiral air pipe inside said three-dimensional rectangular housing to direct moving air passing through said air sterilization lattice into said outgoing air lattice.

4. As recited in claim 3, said three-dimensional rectangular housing is having a spiral air pipe;
said spiral air pipe further comprises of:
a rifle like spiral strip, which allows direct more air passing through said air sterilization lattice into said outgoing air lattice located at both ends of said body.

5. As recited in claim 1, said air purifier is equipped with an electrical circuitry system and a negative ion generator to increase negative ions and purify air in an indoor environment. Said negative ion generation circuitry, and activate circuitry for ultraviolet emission tube that produces ultraviolet wavelength of 253.7 nanometers.

6. As recited in claim 3, said air purifier is equipped with an electrical circuitry system and a negative ion generator to increase negative ions and purify air in an indoor environment. Said negative ion generation circuitry, and activate circuitry for ultraviolet emission tube that produces ultraviolet wavelength of 253.7 nanometers.

7. As recited in claim 1, said air purifier is equipped with an electrical circuitry system and a negative ion generator to increase negative ions and purify air in an indoor environment. Said negative ion generation circuitry, and activate circuitry for ultraviolet emission tube that produces ultraviolet wavelength of 253.7 nanometers and said output value of negative high voltage should be between 4,500 to 8,500 voltages. Said function of the activation circuitry's changeable impedance on ultraviolet tube, which generates ultraviolet at 253.7 nm, is to adjust current's output value.

8. As recited in claim 3, said air purifier is equipped with an electrical circuitry system and a negative ion generator to increase negative ions and purify air in an indoor environment. Said negative ion generation circuitry, and activate circuitry for ultraviolet emission tube that produces ultraviolet wavelength of 253.7 nanometers and said output value of negative high voltage should be between 4;500 to 8,500 voltages. Said function of activation circuitry's changeable impedance on ultraviolet tube, which generates ultraviolet at 253.7 nm, is to adjust current's output value.

9. As recited in claim (1) there are two constant circulation processes. A first one operates intermittently every 8 hours. It ignites ultraviolet to perish bacteria, viruses and mildews in the air, while discharging negative high voltage via carbonization fiber to the air to generate negative ions, which is later released by ventilator. A second one operates intermittently every 4 hours. It stops operations of ultraviolet emission and discharges negative high voltage through carbonization fiber. Said florescent light tube is operated continuously without interruption.

10. As recited in claim (1), there are two constant circulation processes. A first one operates intermittently every 8 hours. It ignites ultraviolet to perish bacteria, viruses and mildews in the air, while discharging negative high voltage via carbonization fiber to the air to generate negative ions, which is later released by ventilator. A second one operates intermittently every 4 hours. It stops operations of ultraviolet emission and discharges negative high voltage through carbonization fiber. Said florescent light tube is operated continuously without interruption.

11. As recited in claim (3), there are two constant circulation processes. A first one operates intermittently every 8 hours. It ignites ultraviolet to perish bacteria, viruses and mildews in the air, while discharging negative high voltage via carbonization fiber to the air to generate negative ions, which is later released by ventilator. A second one operates intermittently every 4 hours. It stops operations of ultraviolet emission and discharges negative high voltage through carbonization fiber. Said florescent light tube is operated continuously without interruption.

12. As recited in claim (1), said air collection wall consists of many spiral air collectors. Structure of said air collectors is based on rifle spiral shape, which directs the air easily and slowly into said body (1), then, forcing entire incoming air to go through said ultraviolet ray emitted by said ultraviolet tube.

13. As recited in claim (3), said air collection wall consists of many spiral air collectors. Structure of said air collectors is based on rifle spiral shape, which directs the air easily and slowly into said body (1), then, forcing entire incoming air to go through said ultraviolet ray emitted by said ultraviolet tube.

14. As recited in claim (1), said air purifier is equipped with a cover door at rear portion of said body for user to replace ultraviolet tube.

15. As recited in claim (3), said air purifier is equipped with a cover door at rear portion of said body for user to replace ultraviolet tube.

16. As recited in claim (1) said air purifier allows said air purifier to stay in remotely control conditions for remotely control all functions and features such as turning on, turning off, to increase or decrease power or level of air out and/or input, to increase and/or decrease level of ions, and/or turning on and off illumination.

17. As recited in claim (3) said air purifier allows said air purifier to stay in remotely control conditions for remotely control all functions and features such as turning on, turning off, to increase or decrease power or level of air out and/or input, to increase and/or decrease level of ions,, and/or turning on and off illumination.

18. As recited in claim 2, said air purifier is equipped with an electrical circuitry system and a negative ion generator to increase negative ions and purify air in an indoor environment. Said negative ion generation circuitry, and activate circuitry for ultraviolet emission tube that produces ultraviolet wavelength of 253.7 nanometers and said output value of negative high voltage should be between 4,500 to 8,500 voltages. Said function of activation circuitry's changeable impedance on ultraviolet tube, which generates ultraviolet at 253.7 nm, is to adjust current's output value. There are two constant circulation processes. A first one operates intermittently every 8 hours. It ignites ultraviolet to perish bacteria, viruses and mildews in the air, while discharging negative high voltage via carbonization fiber to the air to generate negative ions, which is later released by ventilator. A second one operates intermittently every 4 hours. It stops operations of ultraviolet emission and discharges negative high voltage through carbonization fiber. Said florescent light tube is operated continuously without interruption.

19. As recited in claim (2), said air collection wall consists of many spiral air collectors. Structure of said air collectors is based on rifle spiral shape, which directs the air easily and slowly into said body (1), then, forcing entire incoming air to go through said ultraviolet ray emitted by said ultraviolet tube. Said air purifier is also equipped with a cover door at rear portion of said body for user to replace ultraviolet tube.

20. As recited in claim (2) said air purifier allows said air purifier to stay in remotely control conditions for remotely control all functions and features such as turning on, turning off, to increase or decrease power or level of air out and/or input, to increase and/or decrease level of ions, and/or turning on and off illumination.
